(19) United States
(12) Patent Application Publication
(10) Pub. No.: US 2015/0075269 A1
(43) Pub. Date: Mar. 19, 2015

(54) CONTAMINANT MEASUREMENT FOR SENSOR ELEMENT POISONOUS EXHAUST ENVIRONMENT

(71) Applicant: MULTRONIC N.V., Tienen (BE)

(72) Inventor: Christiaan Van Mullem, Tienen (BE)

(21) Appl. No.: 14/403,281

(22) PCT Filed: May 29, 2013
(86) PCT No.: PCT/EP2013/061093

§ 371 Date: Nov. 24, 2014

(30) Foreign Application Priority Data
May 31, 2012 (GB) 1209715.0

(51) Int. Cl. G01M 15/10

(52) U.S. Cl. CPC G01M 15/102
USPC 73/114.71

(57) ABSTRACT

A sensor according to embodiments of the present invention is protected or shielded from exhaust gas under the conditions applying when no measurement is necessary. In embodiments the shield can be a flow of clean air or any other suitable protection gas shield. The present invention provides a sensor wherein close to the sensor in the exhaust system that requires protection as well as calibration, a means for providing a shielding gas is placed adjacent to the sensor element, the means for providing shielding gas being adapted to flow shielding gas over the sensing element when in virtual mode and/or calibration gas in calibration mode so that exhaust gas can not reach the sensor. For example a gas nozzle can be installed blowing a gas such as air over the sensing element when in virtual mode or in calibration mode so that exhaust gas cannot reach the sensor. The sensor and the sensing element in any of the embodiments may be adapted to measure the concentration of NOX, oxygen or NH3.

The present invention relates to methods, systems and devices for exhaust control of internal combustion engines especially diesel engines. The present invention is particularly relevant to methods, systems and devices for exhaust control of internal combustion engines especially diesel engines burning low quality fuel, e.g. containing a high level of contaminants such as sulphur that can poison sensor elements.

### TECHNICAL BACKGROUND

Internal combustion engines as used in automobiles run on high quality fuel. However there are still many internal combustion engines that run on low grade fuel, e.g. diesel oil that contains high levels of sulphur. Engines using low fuel qualities will require emission after-treatment systems in the near future. The combination of internal combustion engines and low quality fuel can be found mainly (but not exclusively) in marine, rail and industrial applications.

After-treatment systems for these applications require permanent monitoring in order to:
Demonstrate to inspecting authorities compliance with emission level regulations.
Manage—control—pilot the after-treatment.

For the monitoring of such systems, fragile sensors are needed to measure the temperature and pressure of exhaust as well as the concentration of NOX, oxygen and in some cases NH₃. These sensors are mounted in the exhaust system and due to poor fuel quality can be damaged by chemical poisoning, dust, ash and particulate matter.

### SUMMARY OF THE INVENTION

It is an object of the present invention to provide alternative methods, systems and devices for exhaust control of internal combustion engines especially diesel engines. The present invention is particularly relevant to methods, systems and devices for exhaust control of internal combustion engines especially diesel engines burning low quality fuel, e.g. containing a high level of contaminants such as sulphur that can poison sensor elements.

In one aspect the present invention is based on the strategy that when an engine is operated in steady state conditions its emissions hardly change. Therefore embodiments of the present invention provide an intelligent sampling method, whereby exhaust gas samples are only taken under one of the following conditions:
Transient—dynamic use of the engine
Steady state use after or when a refreshment of the sample is desired.

Under other conditions it is sufficient to use a previously measured sample and to generate a virtual sample.

This means that the sensing element does not need to be exposed to the harsh environment.

A sensor according to embodiments of the present invention is protected or shielded from exhaust gas under the conditions applying when no measurement is necessary. In embodiments the shield can be a flow of clean air or any other suitable protection gas shield.

The present invention provides a sensor wherein close to the sensor in the exhaust system that requires protection as well as calibration, a means for providing a shielding gas is placed adjacent to the sensor element, the means for providing shielding gas being adapted to flow shielding gas over the sensing element when in virtual mode and/or calibration gas in calibration mode so that exhaust gas can not reach the sensor. For example a gas nozzle can be installed blowing a gas such as air over the sensing element when in virtual mode or in calibration mode so that exhaust gas cannot reach the sensor. The sensor and the sensing element in any of the embodiments may be adapted to measure the concentration of NOX, oxygen or NH₃.

The major advantages of the present invention are one or more of the following:
Extension of life time of the sensor(s)
No engine downtime for calibration
Accurate measurement during transient—dynamic use of the engine.
Response time due to the measurement taking place in the actual exhaust gas stream.

The present invention provides a sensor, a sensor arrangement, a sensing system and method comprising one or more of the following elements.

### 1: Smart Sampling:

Sensors and measurements or variables can be used which are not in the exhaust but which are related to the operation of the engine to determine if there is a need to refresh the sample—reference measurement in the exhaust

### 2: Protection Gas:

Prior art system protect the sensor by installing it in an area that can shielded from the exhaust gas stream with a mechanical construction (coating, bypass, valve system, etc.).

On the contrary, embodiments of the present invention leave the sensor in the exhaust stream (main or bypass) but create a protection with a shielding curtain of gas around the sensor when no measurement is required. The curtain or shield is formed by a gas flow such as air flow generating a protective gas cloud around the sensing element so that the effect of harmful gas on the sensor element is reduced as less exhaust can reach the sensing element

### 3: Calibration

The same shielding gas cloud can be filled with a reference gas. This allows the calibration of the sensor without engine or after-treatment downtime.

The present invention also includes a computer program product containing code segments that executes any of the methods according to the present invention when executed on a processing engine. The present invention also includes a non-transient storage medium storing the computer program product.

### BRIEF DESCRIPTION OF THE FIGURES

FIG. 1 shows: an example of a controller e.g. an electronic device such as a microcontroller or suitably programmed FPGA or microprocessor with some of the possible or optional inputs and outputs in accordance with an embodiment of the present invention.

FIG. 2 shows: an example of a section of the exhaust gas pipe or conduit with the sensors in accordance with an embodiment of the present invention.

FIG. 3 shows: an example of a section of the exhaust gas pipe or conduit with the sensors (side view) in accordance with an embodiment of the present invention.

FIG. 4 shows: an example of section of the exhaust gas pipe or conduit with the sensors (top view) in accordance with an embodiment of the present invention.

FIG. 5 shows: an example of a sensor platform in accordance with an embodiment of the present invention.

### DETAILS DESCRIPTION OF THE PREFERRED EMBODIMENTS

The present invention will be described with respect to particular embodiments and with reference to certain drawings but the invention is not limited thereto but only by the claims.

The present invention relates to methods, systems and devices for exhaust control of internal combustion engines especially diesel engines. The present invention is particularly relevant to methods, systems and devices for exhaust control of internal combustion engines especially diesel engines burning low quality fuel, e.g. containing a high level of contaminants such as sulphur that can poison sensor elements.

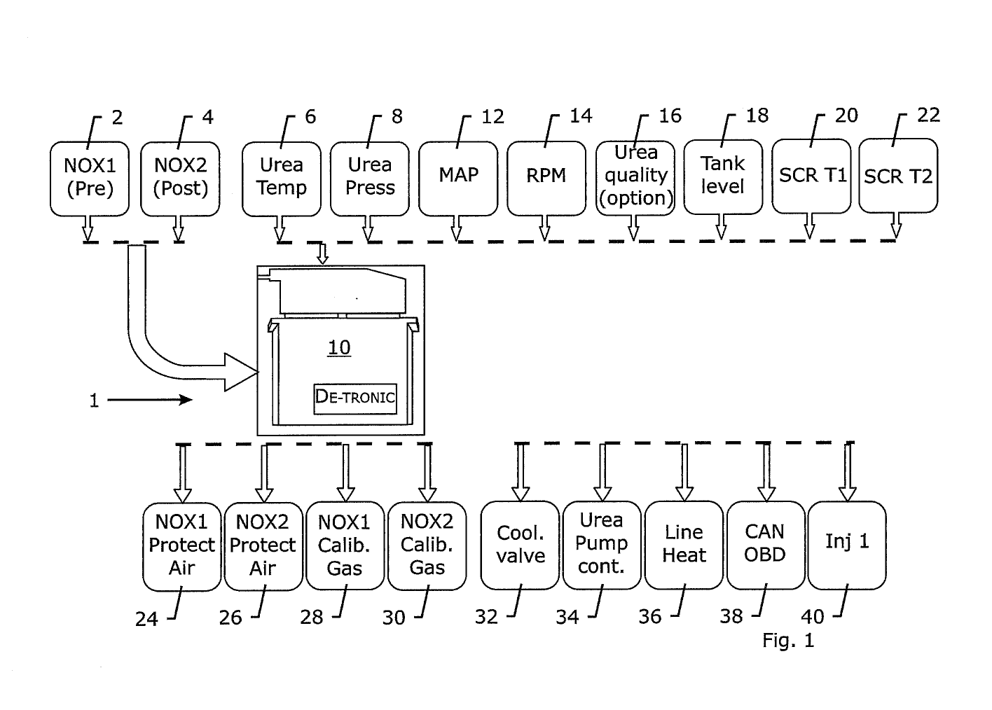

FIG. 1 is a schematic representation of an exhaust control system 1 according to the present invention. It comprises an electronic controller 10 which receives a variety of inputs and is adapted to generate signals that can be used to control various elements of the exhaust control system, e.g. these elements may be actuators. The controller may be any suitable electronic device such as a microcontroller or suitably programmed FPGA or microprocessor.

In particular the controller 10 receives input signals from:
a) contaminant sensors such as NOX sensors 2,4. These NOX sensors may be a pre-aftertreatment device sensor 2 and/or a post-aftertreatment device sensor 4. These sensors measure the amount of NOX in the exhaust gases before and after the sensor elements, the sensor elements being adapted to generate a signal representative of the NOX level in the exhaust gases. The sensors may also be oxygen or NH₃ sensors.
b) Temperature sensors such as a sensor 6 to measure the temperature of urea that may be injected into the exhaust stream.
c) Pressure sensors such as a urea sensor 8 for measuring the pressure of urea that may be injected into the exhaust stream.
d) Quality sensors such as a urea quality sensor 16.
e) Motor state sensors such as a MAP sensor 12 measuring the absolute pressure in the intake manifold, an RPM sensor 14, or fuel tank level sensor 18 but not limited thereto. For example, a Motor State Sensor can provide a signal or information indicating that the operational mode of the engine has changed resulting in a potential change in emissions. This can be for example RPM, MAP (motor Airpressure), Air mass, Instant Fuel consumption, air Humidity, Temperatures of oil, water, EGR position, secondary load like air conditioning, water pumps, alternators, etc etc.

The electronic controller has one or more signal outputs such as:
a) Signals 24 and 26 that can activate the emission of a protective or shielding gas around sensor elements of sensors 2, 4, respectively. The gas may be air for example.
b) Signals 28 and 30 that can activate the emission of a calibration gas for sensor elements of sensors 2, 4, respectively.
c) Valve control signals such as signal 32 to control a valve for engine coolant to heat up the urea tank(s).
d) Pump control signals such as signal 34 to control the urea pump.

e) Temperature control signals such as signal 36 to control the heating of urea supply lines.

f) CAN OBD (38) signals relevant for On Board Diagnostics of the engine.

g) Signal 40 to pilot the reagent dosing/injector (s)

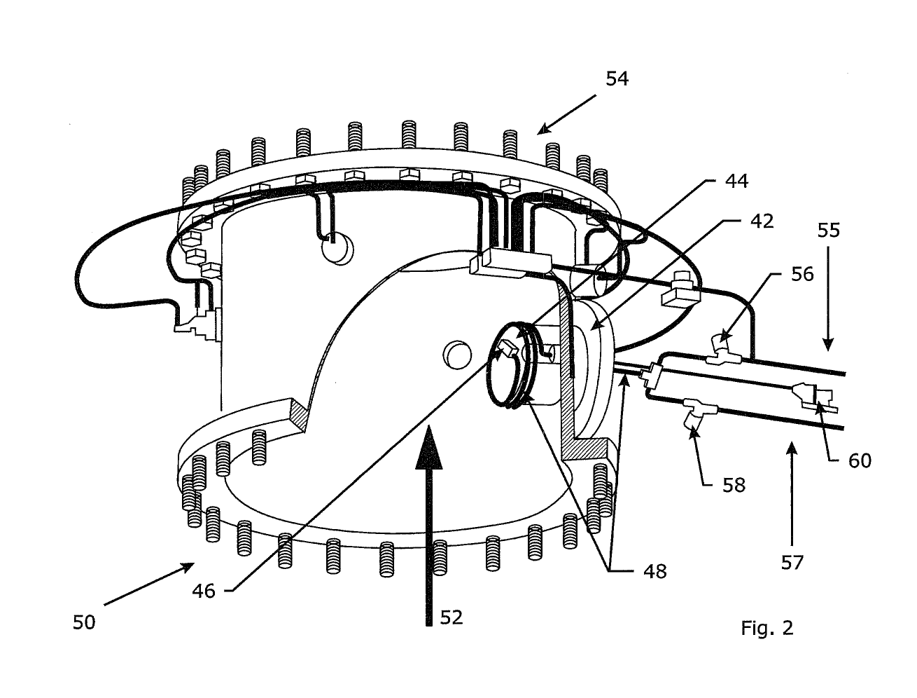

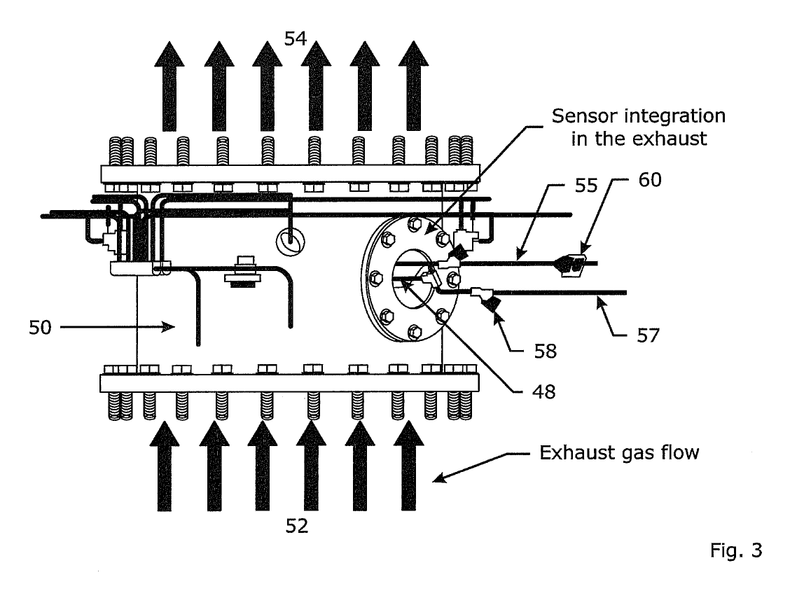

FIGS. 2 and 3 show a portion of an exhaust manifold or conduit 50. Exhaust gases enter at the opening 52 and exit at opening 54. A sensor platform 42 extends into the exhaust conduit 50 and carries a sensor element 44 and a gas nozzle 46. Gas nozzle 46 is supplied with gas such as air via a gas pipe 48. Gas pipe 48 can be supplied with protection or shielding gas through controllable valve 56 and pipe 55 from a suitable source to form a protective cloud around the sensor element 44, or with calibration gas through controllable valve 58 and pipe 57 from a suitable source. Valves 56 and 58 are controlled by signals 24, 26 respectively. Depending from the number of sensors additional control signals may be foreseen as there are signal 28 & 30. The sensor element 44 output is supplied to controller 10 by line 60.

The sensor element 44, gas nozzle 46, and piping 48 all penetrate into the exhaust conduit 50. Electrical readout line 60 is connected the controller 10 on one side and to the sensor element 44 on the other for readout purposes. Valves 56 and 58 are preferably outside the exhaust conduit and are preferably controllable valves connected to suitable control circuitry such as controller 10 for the purposes of controlling the opening and closing of the valves.

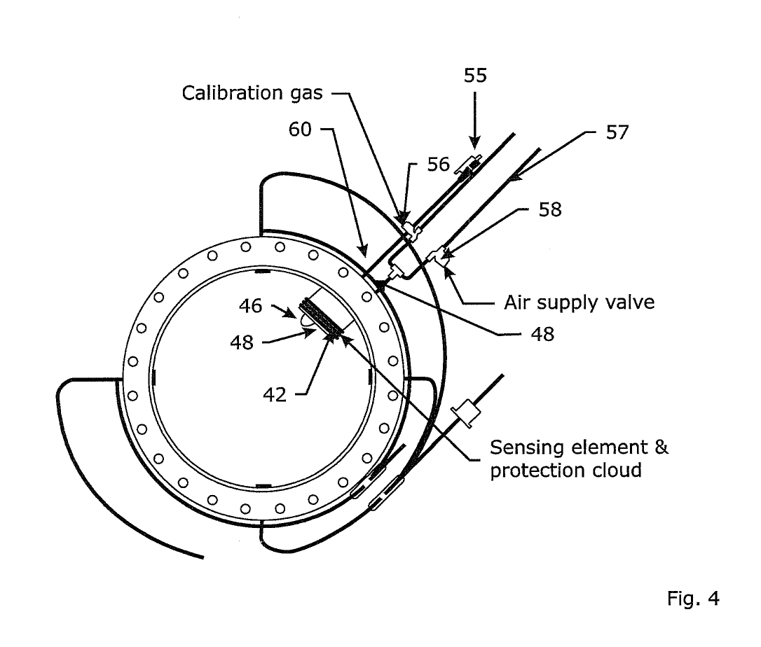

FIG. 4 shows an end view of the conduit 50.

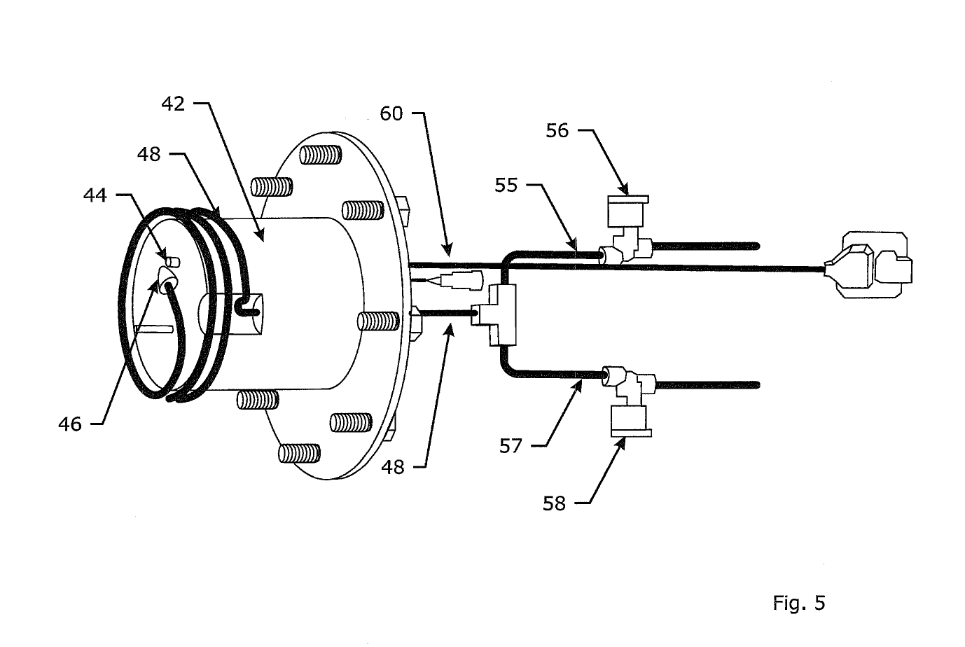

FIG. 5 shows a detail of the sensor platform 42 which can be located in the exhaust stream through a hole in the conduit 50. The sensor platform 42 may be mounted on a flange for fixing to a hole in the exhaust pipe. The operation in various modes will now be described. The motor exhaust can be a diesel motor exhaust for example of a marine engine or any other stationary or moveable internal combustion motor.

### Operation Mode 1

f) In this mode the engine is in steady state. For marine engines steady state conditions can occur for long periods at sea, for example. In such a mode continuous sampling is not required. Controller 10 or any other suitable device is adapted to detect a steady state, e.g. by use of the signals from motor state sensors such as an RPM sensor 14, or MAP sensor 12, but not limited thereto. For example, a Motor State Sensor can provide a signal or information indicating that the operational mode of the engine has changed resulting in a potential change in emissions. This can be for example RPM, MAP (motor Airpressure), Air mass, Instant Fuel consumption, air Humidity, Temperatures of oil, water, EGR position, secondary load like air conditioning, water pumps, alternators, etc etc.

As sampling is not necessary a protection or shielding gas is emitted from nozzle 46. The flow of gas is controlled by signal 24, 26 from controller 10 operating on valve 56 which is opened.

### Operation Mode 2

In operation mode 2 the engine is also in steady state as determined by controller 10 or any other suitable device and hence constant sampling is not required. However the sensor needs periodic calibration. In this mode the valve 56 is closed and valve 58 is opened to allow flow of calibration gas. This opening is controlled by signals 28 or 30 from controller 10. The control unit 10 and the electronic platform performs the function of adjusting the calibration of the sensor. manages the sensor because will also generate a code when the sensor drift is too important and that it will need replacement)

### Operation Mode 3

In operation mode 3 the engine is in a transient condition as determined by controller 10 or any other suitable device and hence constant sampling is required. In this mode both valves 56 and 58 are closed as determined by signals 24, 26 and 28, 30 respectively from controller 10. The sensor output is then sampled regularly.

In one aspect the present invention is based on the strategy that when an engine is operated in steady state conditions its emissions hardly change. Therefore embodiments of the present invention provide an intelligent sampling method, whereby exhaust gas samples are only taken under one of the following conditions:
Transient—dynamic use of the engine
Steady state use after when a refreshment of the sample is desired.
During the (re) calibration of the sensor.

Under other conditions it is sufficient to use a previously measured sample and to generate a virtual sample.

This means that the sensing element does not need to be exposed to the harsh environment.

As can be understood from the above and the attached figures a sensor according to embodiments of the present invention is protected or shielded from exhaust gas under the conditions applying when no measurement is necessary, i.e. mode 1. In embodiments the shield can be a flow of clean air or any other suitable protection gas shield.

The present invention provides a sensor wherein close to the sensor in the exhaust system that requires protection as well as calibration, a means for providing a shielding gas is placed adjacent to the sensor element, the means for providing shielding gas being adapted to flow shielding gas over the sensing element when in virtual mode or in calibration mode so that exhaust gas can not reach the sensor. For example the gas nozzle 46 is installed for blowing a gas such as air over the sensing element 44 when in virtual mode or a calibration gas in calibration mode so that exhaust gas can not reach the sensor. The sensor and the sensing element in any of the embodiments may be adapted to measure the concentration of NOX, oxygen or NH₃.

The major advantages of the present invention are one or more of the following:
Extension of life time of the sensor(s)
No engine downtime for calibration
Accurate measurement during transient—dynamic use of the engine.
Response time due to the measurement taking place in the actual exhaust gas stream.

The present invention provides a sensor, a sensor arrangement, a sensing system and method comprising one or more of the following elements.

### 1: Smart Sampling:

Sensors and measurements or variables can be used which are not in the exhaust but which are related to the operation of the engine to determine if there is a need to refresh the sample—reference measurement in the exhaust.

### 2: Protection Gas:

Prior art system protect the sensor by installing it in an area that can shielded from the exhaust gas stream with a mechanical construction (coating, bypass, valve system, etc.). On the contrary, embodiments of the present invention leave the sensor in the exhaust stream (main or bypass) but create a protection with a shielding curtain of gas around the sensor when no measurement is required. The curtain or shield is formed by a constant gas flow such as air flow generating a protective gas cloud around the sensing element so that the effect of harmful gas on the sensor element is reduced as less exhaust can reach the sensing element

### 3: Calibration

The same shielding gas cloud can be filled with a reference gas. This allows the calibration of the sensor without engine or after-treatment downtime.

The present invention also includes a computer program product, i.e. software, for use in the controller 10, which has code segments which when executed on a processing engine such as an FPGA or a microprocessor activates the flowing of a shielding gas or calibration gas in a calibration mode so that a reduced amount of exhaust gas can reach the sensor element.

The software may include code adapted to determine if there is a need to perform a refresh sampling or reference measurement of the exhaust gas.

The software may include code adapted to determine that the engine is in steady state and emitting of shielding gas around the sensor element.

The software may include code adapted to determine a steady state from the output of a motor state sensor.

The software may include code adapted to determine that the engine is in steady state and to activate emission of a calibration gas to the sensor element periodically.

The software may include code adapted to determine that the engine is not in a steady state and to suppress emission of calibration gas or shielding gas to the sensor element.

The software may be stored on a signal storage medium, e.g. an optical storage medium such as a CD-ROM or a DVD-ROM, a magnetic tape, a magnetic disk, a diskette, a solid state memory etc.

1. A sensor arrangement for use in an exhaust gas system with streaming exhaust gas from an engine, comprising
a sensor element adapted to be reached by the exhaust gas,
a controller, and means for providing a shielding gas located adjacent to the sensor element, the means for providing shielding gas being adapted to flow shielding gas over the sensing element when in a virtual mode and/or calibration gas in a calibration mode so that a reduced amount of exhaust gas can reach the sensor element.

2. The sensor arrangement of claim 1 wherein the means for providing a shielding gas is a gas nozzle adapted for blowing a gas over the sensing element when in virtual mode or calibration gas in calibration mode so that a reduced amount of exhaust gas can reach the sensor.

3. The sensor arrangement according to claim 1, wherein the controller is adapted to determine that the engine is in steady state and to provide a signal to activate emission of shielding gas to the sensor element.

4. The sensor arrangement according to claim 1, wherein the controller is adapted to determine that the engine is in steady state and to provide a signal to activate emission of calibration gas to the sensor element periodically.

5. The sensor arrangement according to claim 4 wherein the controller is adapted to detect a steady state by use of input signals from a motor state sensor.

6. The sensor arrangement according to claim 4, wherein the controller is adapted to emit a second control signal to operate a second valve for releasing calibration gas.

7. The sensor arrangement according to claim 1, wherein the controller is adapted to determine that the engine is not in a steady state and to provide a signal to suppress emission of calibration gas or shielding gas to the sensor element.

8. A method of sensing an exhaust gas system with streaming exhaust gas from an engine, the exhaust gas system having a sensor element that can be reached by the exhaust gas, the method comprising: flowing a shielding gas or calibration gas in a calibration mode so that a reduced amount of exhaust gas can reach the sensor element.

9. The method of claim 8 further comprising determining if there is a need to perform a refresh sampling or reference measurement of the exhaust gas.

10. The method according to claim 8 comprising determining that the engine is in 10 steady state and emitting of shielding gas around the sensor element.

11. The method according to claim 10 wherein comprising detecting a steady state is from a motor state sensor.

12. The method according to claim 8 comprising determining that the engine is in steady state and emitting a calibration gas to the sensor element periodically.

13. The method according to claim 8 comprising determining that the engine is not in a steady state and suppressing emission of calibration gas or shielding gas to the 20 sensor element.

14. A computer program product containing code segments that executes any of the methods according to claim 8, when executed on a processing engine.

15. A non-transient storage medium storing the computer program product of claim 14.
